(19) United States
(12) Patent Application Publication
(10) Pub. No.: US 2023/0299892 A1
(43) Pub. Date: Sep. 21, 2023

(54) METHOD AND APPARATUS FOR FREQUENCY DOMAIN RESOURCE DETERMINATION FOR PHYSICAL SIDELINK FEEDBACK CHANNEL

(71) Applicant: Samsung Electronics Co., Ltd., Suwon-si, Gyeonggi-do (KR)

(72) Inventors: Hongbo Si, Plano, TX (US); Emad N. Farag, Flanders, NJ (US); Carmela Cozzo, San Diego, CA (US); Kyeongin Jeong, Allen, TX (US)

(21) Appl. No.: 18/175,390

(22) Filed: Feb. 27, 2023

Related U.S. Application Data
(60) Provisional application No. 63/321,483, filed on Mar. 18, 2022.

(51) Int. Cl. H04L 1/1829; H04W 72/25

(52) U.S. Cl. CPC H04L 1/1861; H04W 72/25; H04L 1/1812

(57) ABSTRACT

Methods and apparatuses for frequency domain enhancement on physical sidelink feedback channel (PSFCH) in a wireless communication system. A method of operating user equipment (UE) includes receiving a physical sidelink shared channel (PSSCH) that enables a hybrid automatic repeat request (HARQ) feedback and determining an interlace from a set of interlaces. Each interlace in the set of interlaces includes a first set of resource blocks (RBs) with a uniform interval. The method further includes determining a RB set with contiguous RBs, determining, based on an intersection between the interlace and the RB set, a second set of RBs for a physical sidelink feedback channel (PSFCH) transmission, performing a sidelink (SL) channel access procedure and transmitting, after successfully performing the SL channel access procedure, the PSFCH carrying the HARQ feedback in the second set of RBs.

### CROSS-REFERENCE TO RELATED APPLICATIONS AND CLAIM OF PRIORITY

The present application claims priority under 35 U.S.C. § 119(e) to U.S. Provisional Patent Application No. 63/321,483, filed on Mar. 18, 2022. The above-identified provisional patent application is incorporated herein by reference.

### TECHNICAL FIELD

The present disclosure relates generally to wireless communication systems and, more specifically, the present disclosure relates to frequency domain resource determination for a physical sidelink (SL) feedback channel (PSFCH) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, and new multiple access schemes to support massive connections.

### SUMMARY

The present disclosure relates to wireless communication systems and, more specifically, the present disclosure relates to frequency domain resource determination for a PSFCH in a wireless communication system.

In one embodiment, a user equipment (UE) in a wireless communication system operating with a shared spectrum channel access is provided. The UE includes a transceiver configured to receive a physical sidelink shared channel (PSSCH). The PSSCH enables a hybrid automatic repeat request (HARQ) feedback. The UE further includes a processor operably coupled to the transceiver. The processor is configured to determine an interlace from a set of interlaces. Each interlace in the set of interlaces includes a first set of resource blocks (RBs) with a uniform interval. The processor is further configured to determine an RB set. The RB set includes contiguous RBs. The processor is further configured to determine, based on an intersection between the interlace and the RB set, a second set of RBs for a PSFCH transmission and perform a SL channel access procedure. The transceiver is further configured to transmit, after successfully performing the SL channel access procedure, the PSFCH carrying the HARQ feedback in the second set of RBs.

In another embodiment, a method of UE in a wireless communication system operating with a shared spectrum channel access is provided. The method includes receiving a PSSCH that enables a HARQ feedback and determining an interlace from a set of interlaces. Each interlace in the set of interlaces includes a first set of RBs with a uniform interval. The method further includes determining an RB set that includes contiguous RBs, determining, based on an intersection between the interlace and the RB set, a second set of RBs for a PSFCH transmission, performing a SL channel access procedure and transmitting, after successfully performing the SL channel access procedure, the PSFCH carrying the HARQ feedback in the second set of RBs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of resource pool in Rel-16 NR V2X according to embodiments of the present disclosure;

FIG. 7 illustrates an example of time domain resource determination for PSFCH according to embodiments of the present disclosure;

FIG. 8 illustrates an example of frequency domain resource determination for PSFCH according to embodiments of the present disclosure;

FIG. 9A illustrates an example of a PSFCH transmission occupying one or multiple interlaces in the frequency domain, each interlace corresponding to a set of resource blocks (RBs) according to embodiments of the present disclosure;

FIG. 9B illustrates an example of a PSFCH transmission occupying one or multiple interlaces in the frequency domain, each interlace corresponding to a set of resource elements (REs) according to embodiments of the present disclosure;

FIG. 9C illustrates an example of a PSFCH transmission occupying one or multiple one or multiple contiguous RBs in the frequency domain according to embodiments of the present disclosure;

FIG. 9D illustrates an example of a PSFCH transmission occupying all RBs in the frequency domain according to embodiments of the present disclosure; and

FIG. 10 illustrates a flowchart of a UE method for a PSFCH transmission occupying one or multiple interlaces in the frequency domain, each interlace corresponding to a set of resource blocks (RBs) according to embodiments of the present disclosure.

### DETAILED DESCRIPTION

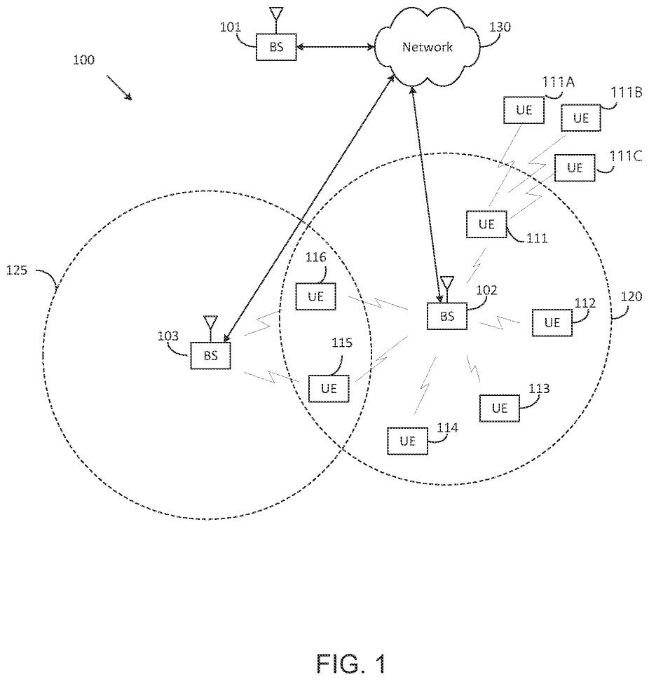

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.6.0, “NR; Physical channels and modulation”; 3GPP TS 38.212 v16.6.0, “NR; Multiplexing and Channel coding”; 3GPP TS 38.213 v16.6.0, “NR; Physical Layer Procedures for Control”; 3GPP TS 38.214 v16.6.0, “NR; Physical Layer Procedures for Data”; and 3GPP TS 38.331 v16.5.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNodeB (gNB) 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for frequency domain resource determination for a PSFCH in a wireless communication system. In certain embodiments, and one or more of the gNBs 101-103 includes circuitry, programing, or a combination thereof, for frequency domain resource indication for a PSFCH in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

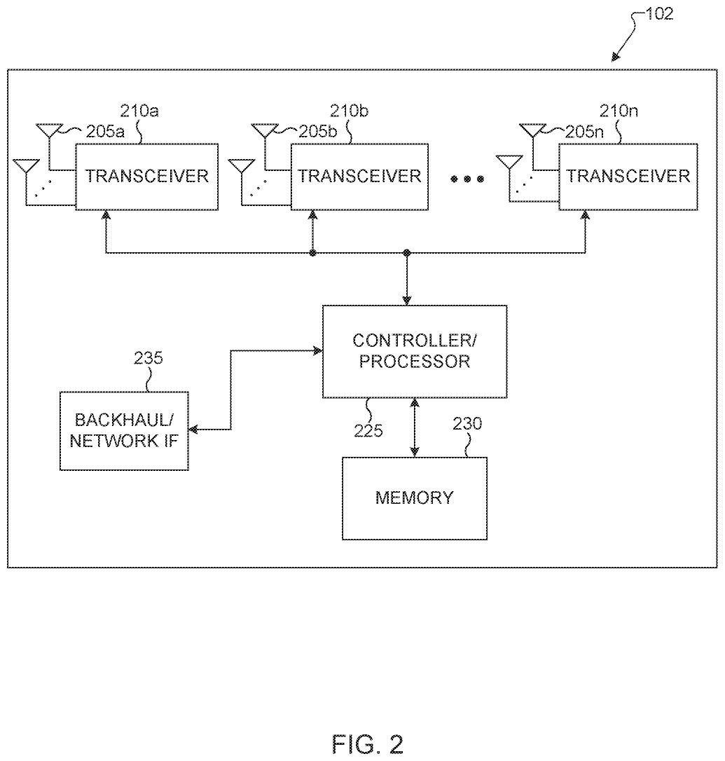

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for a frequency domain resource indications for a PSFCH in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

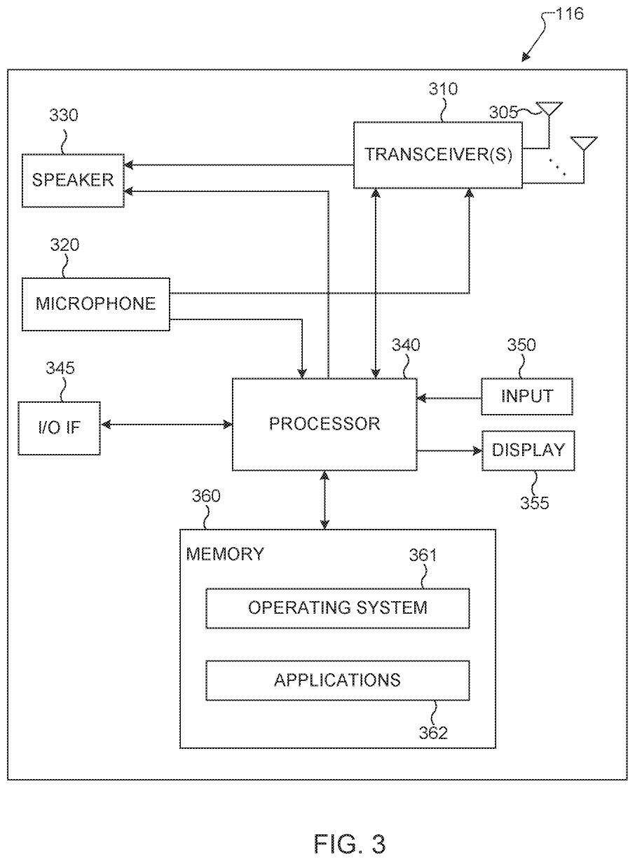

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for frequency domain resource determination for a PSFCH in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

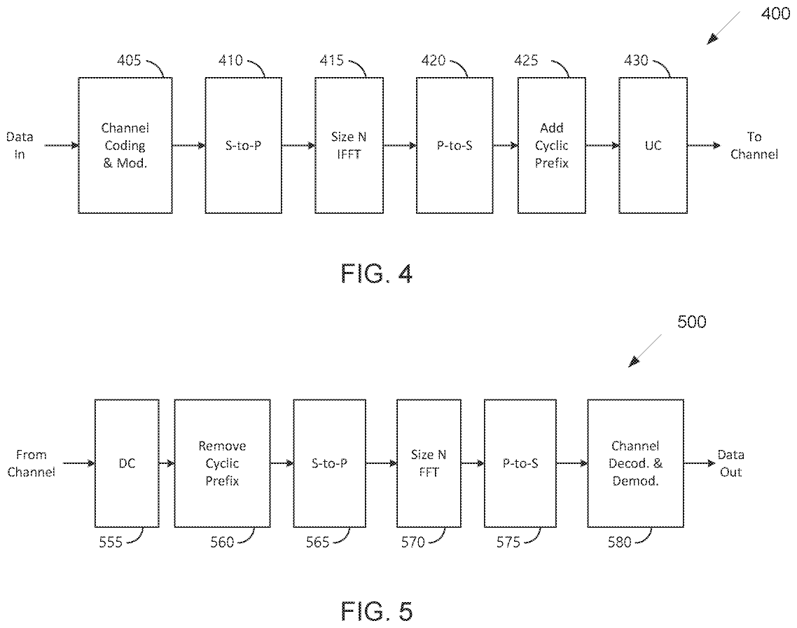

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In various embodiments, the transmit path 400 may be described as being implemented in a first UE (such as a UE 111) and the receive path 500 may be described as being implemented in a second UE (such as a UE 111A) for communication over a SL or vice versa. In some embodiments, the receive path 500 is configured to receive a PSFCH on determined frequency domain resources.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 or UE 111 arrives at the UE 116 or 111A after passing through the wireless channel, and reverse operations to those at the gNB 102 or UE 111 are performed at the UE 116 or 111A.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103. Additionally, in various embodiments, each of the UEs 111-116 may implement a transmit path 400 as illustrated in FIG. 4 that is analogous to transmitting in the SL to others of the UEs 111-116 and may implement a receive path 500 as illustrated in FIG. 5 that is analogous to receiving in the SL from others of the UEs 111-116.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

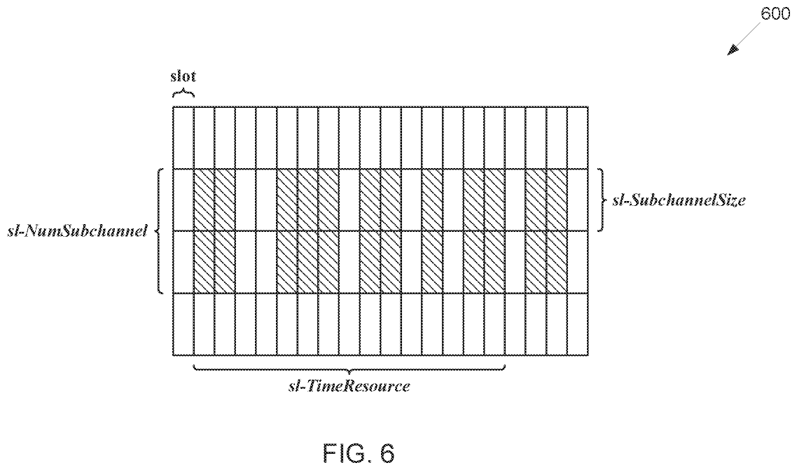

In Rel-16 NR V2X, transmission and reception of SL signals and channels are based on resource pool(s) confined in the configured SL bandwidth part (BWP). In the frequency domain, a resource pool consists of a (pre-)configured number (e.g., sl-NumSubchannel) of contiguous sub-channels, wherein each sub-channel consists of a set of contiguous resource blocks (RBs) in a slot with size (pre-)configured by higher layer parameter (e.g., sl-SubchannelSize). In time domain, slots in a resource pool occur with a periodicity of 10240 ms, and slots including S-SSB, non-UL slots, and reserved slots are not applicable for a resource pool. The set of slots for a resource pool is further determined within the remaining slots, based on a (pre-)configured bitmap (e.g., sl-TimeResource). An illustration of a resource pool is shown in FIG. 6.

FIG. 6 illustrates an example of resource pool in Rel-16 NR V2X 600 according to embodiments of the present disclosure. The embodiment of the resource pool in Rel-16 NR V2X 600 illustrated in FIG. 6 is for illustration only.

A transmission and reception of physical sidelink shared channel (PSSCH), physical a sidelink control channel (PSCCH), and a physical sidelink feedback channel (PSFCH) are confined within and associated with a resource pool, with parameters (pre-)configured by higher layers (e.g., SL-PSSCH-Config, SL-PSCCH-Config, and SL-PSFCH-Config, respectively).

A UE may transmit the PSSCH in consecutive symbols within a slot of the resource pool, and PSSCH resource allocation starts from the second symbol configured for sidelink, e.g., startSLsymbol+1, and the first symbol configured for sidelink is duplicated from the second configured for sidelink, for AGC purpose. The UE may not transmit PSSCH in symbols not configured for sidelink, or in symbols configured for PSFCH, or in the last symbol configured for sidelink, or in the symbol immediately preceding the PSFCH. The frequency domain resource allocation unit for PSSCH is the sub-channel, and the sub-channel assignment is determined using the corresponding field in the associated SCI.

For transmitting a PSCCH, the UE can be provided a number of symbols (either 2 symbols or 3 symbols) in a resource pool (e.g., sl-TimResourcePSCCH) starting from the second symbol configured for sidelink, e.g., startSLsymbol+1; and further provided a number of RBs in the resource pool (e.g., sl-FreqResourcePSCCH) starting from the lowest RB of the lowest sub-channel of the associated PSSCH.

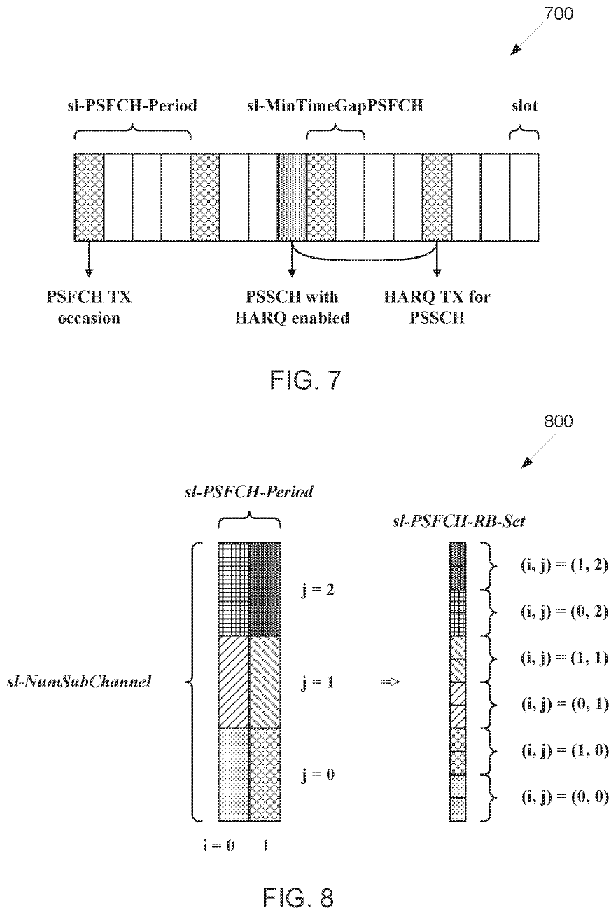

In time domain, the UE can be further provided a number of slots (e.g., sl-PSFCH-Period) in the resource pool for a period of PSFCH transmission occasion resources, and a slot in the resource pool is determined as containing a PSFCH transmission occasion, if the relative slot index within the resource pool is an integer multiple of the period of PSFCH transmission occasion, and with at least a number of slots provided by sl-MinTimeGapPSFCH after the last slot of the PSSCH reception. PSFCH is transmitted in two contiguous symbols in a slot, wherein the second symbol is with index startSLsymbols+lengthSLsymbols−2, and the two symbols are repeated. An illustration of the time domain resource determination for PSFCH is illustrated in FIG. 7.

FIG. 7 illustrates an example of time domain resource determination for PSFCH 700 according to embodiments of the present disclosure. The embodiment of the time domain resource determination for PSFCH 700 illustrated in FIG. 7 is for illustration only.

In a frequency domain, a PSFCH is transmitted in a single PRB, wherein the PRB is determined from a set of M_{PRB,set}^{PSFCH} PRBs based on an indication of a bitmap (e.g., sl-PSFCH-RB-PRB, set Set). The UE determines a mapping from slot i (within N_{PSSCH}^{PSFCH} slots provided by sl-PSFCH-Period) and sub-channel j (within N_{subch} sub-channels provided by sl-NumSubchannel) to a subset of PRBs within the set of M_{PRB,set}^{PSFCH} wherein the subset of PRBs are with index from (i+j·N_{PSSCH}^{PSFCH})·m_{subch,slot}^{PSFCH} to (i+1+j·N_{PSSCH}^{PSFCH})·M_{subch,slot}^{PSFCH}−1, with m_{subch,slot}^{PSFCH}=M_{PRB,set}^{PSFCH}/(N_{subch}·N_{PSSCH}^{PSFCH}).

FIG. 8 illustrates an example of frequency domain resource determination for PSFCH 800 according to embodiments of the present disclosure. The embodiment of the frequency domain resource determination for PSFCH 800 illustrated in FIG. 8 is for illustration only.

An illustration of this mapping is shown in FIG. 8. The UE determines a number of PSFCH resources available for multiplexing HARQ-ACK information in a PSFCH transmission as R_{PRB,CS}^{PSFCH}=N_{type}^{PSFCH}·M_{subch,slot}^{PSFCH}·N_{CS}^{PSFCH}, wherein N_{type}^{PSFCH} is determined based on the type of resources that the PSFCH is associated with, and N_{CS}^{PSFCH} is a number of cyclic shift pairs for the resource pool provided by sl-NumMuxCS-Pair. The UE determines an index of a PSFCH resource for a PSFCH transmission in response to a PSSCH reception as (P_{ID}+M_{ID}) mod R_{PRB,CS}^{PSFCH} where P_{ID} is the source ID provided by the SCI scheduling the PSSCH, and M_{ID} is the PSSCH receiver ID in groupcast SL transmission with ACK or NACK information in HARQ-feedback. Based on this approach, a PSFCH resource can span one or multiple RBs in the frequency domain, which typically cannot meet the occupied channel bandwidth (OCB) requirement for operation unlicensed or shared spectrum (e.g., 80% of the channel bandwidth for 5 GHz unlicensed spectrum).

Various embodiments of the present disclosure recognize that, for sidelink operating on unlicensed or shared spectrum, there is a need to enhance the PSFCH in frequency domain, such that the PSFCH transmission can satisfy the regulation of occupied channel bandwidth (OCB) and/or power spectral density (PSD) requirement. It is noted that the embodiments and/or examples in this disclosure can be used for sidelink operating on unlicensed or shared spectrum, but are not limited to sidelink operating on unlicensed or shared spectrum. The embodiments and examples in this disclosure can be supported separately or combined.

The present disclosure provides embodiments for enhancing the PSFCH in frequency domain, such that the PSFCH transmission can satisfy the regulation of OCB and/or PSD requirement. More precisely, the following components are provided in the present disclosure: (1) a PSFCH transmission can occupy one or multiple interlaces corresponding to a set of resource blocks (RBs); (2) a PSFCH transmission can occupy one or multiple interlaces corresponding to a set of resource elements (REs); (3) a PSFCH transmission can occupy one or multiple contiguous RBs; and (4) a PSFCH transmission can occupy all RBs. The components in this disclosure can increase the span of PSFCH transmission in the frequency domain, which can achieve the OCB requirement for operation with unlicensed or shared spectrum.

In one embodiment, a PSFCH transmission can include at least one or multiple interlaces in the frequency domain, wherein each interlace correspond to a set of resource blocks (RBs) with a uniform interval between neighboring two resource blocks in the frequency domain. In one example, the RBs in the interlace can be with a subcarrier spacing of 15 kHz, and the uniform interval can be 10 RBs such that the number of RBs in the interlace is at least 10. In another example, the RBs in the interlace can be with a subcarrier spacing of 30 kHz, and the uniform interval can be 5 RBs such that the number of RBs in the interlace is at least 10. In yet another example, the RBs in the interlace can be with a subcarrier spacing of 60 kHz, and the uniform interval can be 2 (or 3) RBs such that the number of RBs in the interlace is at least 12 (or 8).

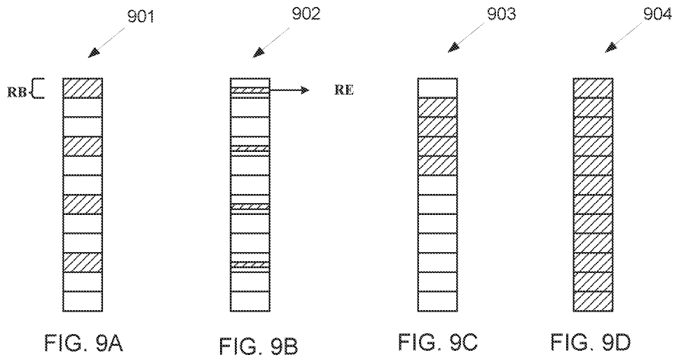

FIG. 9A illustrates an example of a PSFCH transmission occupying one or multiple interlaces in the frequency domain, each interlace corresponding to a set of RBs 901 according to embodiments of the present disclosure. The embodiment of the PSFCH transmission occupying one or multiple interlaces in the frequency domain, each interlace corresponding to a set of RBs 901 illustrated in FIG. 9A is for illustration only.

In one aspect, the one or multiple interlaces for PSFCH transmission can be determined from a set of interlaces.

In one example, the set of interlaces can be associated with the resource pool and/or the sidelink bandwidth part (BWP).

In another example, the set of interlaces can be all the interlaces included in the resource pool and/or the sidelink bandwidth part (BWP).

In yet another example, the set of interlaces can be further confined within a listen before talk (LBT) bandwidth (e.g., a RB-set) wherein a RB-set is a set of contiguous RBs confined within a bandwidth that the channel access procedure is performed. In one sub-example, the RB-set can be the one where the associated PSSCH is transmitted. In another sub-example, when the associated PSSCH transmission spans multiple RB-sets, the RB-set can be determined as the one with the lowest index, or highest index, or with an index provided by a (pre-)configuration, or with an index provided by a sidelink control information (SCI) format. In yet another sub-example, when the associated PSSCH transmission spans multiple RB-sets, the RB-set can be determined as everyone in the multiple RB-sets, e.g., PSFCH is transmitted in every RB-set within the multiple RB-sets. In yet another sub-example, when the associated PSSCH transmission spans multiple RB-sets, the RB-set can be determined as one or multiple from the multiple RB-sets, wherein the one or multiple RB-set can be provided by a (pre-)configuration, or by a SCI format.

In one example, the set of interlaces can be provided to the UE by a pre-configuration. In another example, the set of interlaces can be provided to the UE by a higher layer parameter. In yet another example, the set of interlaces can be provided to the UE by a MAC CE. In yet another example, the set of interlaces can be provided to the UE by a SCI format.

In one example, the set of interlaces can be provided to the UE by a bitmap, wherein a bit taking value of 1 indicates that the corresponding interlace can be used for PSFCH transmission (e.g., included in the set of interlaces), and a bit taking value of 0 indicates that the corresponding interlace is not used for PSFCH transmission (e.g., not included in the set of interlaces).

In another example, the set of interlaces can be provided to the UE by a starting index and duration of the index (e.g., can be provided separately or jointly using a SLIV).

In another aspect, the index(es) of the one or multiple interlaces can be one or multiple of the following examples.

In one example, it can be the index of the interlace within the resource pool. In another example, it can be the index of the interlace within the SL BWP. In yet another example, it can be the index of the interlace within the LBT bandwidth (e.g., RB-set) and the resource pool at the same time (e.g., the indexing is first performed within RB-sets, and then performed for interlaces in the RB-set).

In one further consideration, when a sub-channel corresponds to a RB-based interlace, the index of an interlace can be equivalent to the index of a sub-channel.

In another aspect, the one or multiple interlaces included in a PSFCH transmission can be determined from the set of interlaces according to one or multiple of the following examples.

In one example, the index(es) of the one or multiple interlaces can be provided to the UE by a pre-configuration. In another example, the index(es) of the one or multiple interlaces can be provided to the UE by a higher layer parameter. In yet another example, the index(es) of the one or multiple interlaces can be provided to the UE by a MAC CE.

In yet another example, the index(es) of the one or multiple interlaces can be provided to the UE by a SCI format (e.g., the SCI which scheduling the PSSCH associated with the PSFCH transmission).

In yet another example, the index(es) of the one or multiple interlaces can be calculated by the UE based on the time domain and/or frequency domain information of the PSSCH associated with the PSFCH transmission.

In yet another aspect, there can be a mapping between a time domain index i and a frequency domain index j to a set of index(es) of interlace(s). For instance, the mapping can be expressed as (i, j) to [(i+j·c₁)·c₂, (i+1+j·c₁)·c₂−1].

In one example, i can be the time domain unit index (e.g., slot index or slot group index) within the number of time domain units (e.g., slots or slot groups) associated with the PSFCH transmission occasion.

In another example, j can be the index of the sub-channel within all sub-channels of the resource pool.

In yet another example, j can be the index of the sub-channel within all sub-channels of a LBT bandwidth (e.g., RB-set). In one sub-example, the RB-set can be the one where the associated PSSCH is transmitted. In another sub-example, when the associated PSSCH transmission spans multiple RB-sets, the RB-set can be determined as the one with the lowest index, or highest index, or with an index provided by a (pre-)configuration, or with an index provided by a sidelink control information (SCI) format. In yet another sub-example, when the associated PSSCH transmission spans multiple RB-sets, the RB-set can be determined as all the RB-sets in the multiple RB-sets, e.g., PSFCH is transmitted in every RB-set within the multiple RB-sets. In yet another sub-example, when the associated PSSCH transmission spans multiple RB-sets, the RB-set can be determined as one or multiple from the multiple RB-sets, wherein the one or multiple RB-set can be provided by a (pre-)configuration, or by a SCI format.

In yet another example, c₁ can be the number of time domain units (e.g., slots or slot groups) associated with the PSFCH transmission occasion.

In yet another example, c₂=Nᵢₙₜ/(Nⱼ·Nᵢ), wherein Nᵢₙₜ is the number of interlaces in the set of interlaces for determining the interlace(s) for PSFCH transmission, Nⱼ is the number of index(es) that j can choose from (e.g. 0≤j≤Nⱼ−1), and Nᵢ is the number of index(es) that i can choose from (e.g. 0≤i≤Nᵢ−1).

In yet another aspect, there can be a mapping between a frequency domain index j to a set of indices of interlace(s). For instance, the mapping can be expressed as j to [j·c₂, (j+1) c₂−1].

In one example, j can be the index of the sub-channel within all sub-channels of the resource pool.

In another example, j can be the index of the sub-channel within all sub-channels of the LBT bandwidth (e.g., RB-set). In one sub-example, the RB-set can be the one where the associated PSSCH is transmitted. In another sub-example, when the associated PSSCH transmission spans multiple RB-sets, the RB-set can be determined as the one with the lowest index, or highest index, or with an index provided by a (pre-)configuration, or with an index provided by a sidelink control information (SCI) format. In yet another sub-example, when the associated PSSCH transmission spans multiple RB-sets, the RB-set can be determined as all the RB-sets in the multiple RB-sets, e.g., PSFCH is transmitted in every RB-set within the multiple RB-sets. In yet another sub-example, when the associated PSSCH transmission spans multiple RB-sets, the RB-set can be determined as one or multiple from the multiple RB-sets, wherein the one or multiple RB-set can be provided by a (pre-)configuration, or by a SCI format.

In yet another example, c₂=Nᵢₙₜ/Nⱼ, wherein Nᵢₙₜ is the number of interlaces in the set of interlaces for determining the interlace(s) for PSFCH transmission, Nⱼ is the number of index(es) that j can choose from (e.g. 0≤j≤Nⱼ−1).

In yet another aspect, there can be a one-to-one mapping between a frequency domain index j to an index of interlace. For instance, the index of interlace can be same as the frequency domain index j.

In one example, j can be the index of the sub-channel within all sub-channels of the resource pool.

In another example, j can be the index of the sub-channel within all sub-channels of the LBT bandwidth (e.g., RB-set). In one sub-example, the RB-set can be the one where the associated PSSCH is transmitted. In another sub-example, when the associated PSSCH transmission spans multiple RB-sets, the RB-set can be determined as the one with the lowest index, or highest index, or with an index provided by a (pre-)configuration, or with an index provided by a sidelink control information (SCI) format. In yet another sub-example, when the associated PSSCH transmission spans multiple RB-sets, the RB-set can be determined as all the RB-sets in the multiple RB-sets, e.g., PSFCH is transmitted in every RB-set within the multiple RB-sets. In yet another sub-example, when the associated PSSCH transmission spans multiple RB-sets, the RB-set can be determined as one or multiple from the multiple RB-sets, wherein the one or multiple RB-set can be provided by a (pre-)configuration, or by a SCI format.

In yet another aspect, the transmission of PSFCH is with the same LBT bandwidth (e.g., RB-set) as the transmission of the associated PSSCH, e.g., when the PSSCH transmission is confined within one RB-set.

In yet another aspect, the one or multiple interlaces for PSFCH transmission can be determined based on the time domain and/or frequency domain resources for the associated PSSCH transmission, e.g., based on a mapping described in the example(s) of this disclosure.

In one example, one interlace is selected from the one or multiple interlaces for PSFCH transmission based on the value of i and minimum value of j applicable for the transmission of the associated PSSCH. In one sub-example, this example can be (pre-)configurable.

In another example, one interlace is selected from the one or multiple interlaces for PSFCH transmission based on the value of i and all values of j applicable for the transmission of the associated PSSCH. In one sub-example, this example can be (pre-)configurable.

In yet another aspect, the sequence for PSFCH transmission, which is mapped to the RBs in the interlace(s), can be determined according to at least one of the following examples.

In one example, a sequence with the length same as the number of REs within all the RBs in the interlace(s) for PSFCH transmission is generated and mapped to the REs within all the RBs in the interlace(s) for PSFCH transmission.

In another example, a sequence with the length same as the number of REs within one RB is generated, and the sequence is applied with a cyclic shift and mapped to each RB within all the RBs in the interlace(s) for PSFCH transmission. In one sub-example, the cyclic shift depends on the RB index within all the RBs in the interlace(s) for PSFCH transmission.

In one sub-example, there can be a fixed cyclic shift offset between the neighboring RBs (e.g., the cyclic shift includes a term in the form of cᵢₙₜ·nᵢₙₜ, wherein nᵢₙₜ is the RB index within the interlace, and cᵢₙₜ is a fixed value. For instance, cᵢₙₜ=5. In another instance, cᵢₙₜ=2. In yet another instance, cᵢₙₜ=3). Various embodiments may also refer to the RB index within the interlace as mᵢₙₜ and the terms “nᵢₙₜ” and “mᵢₙₜ” may be used interchangeably in these embodiments.

In another sub-example, there can be a configured cyclic shift offset between the neighboring RBs (e.g., the cyclic shift includes a term in the form of cᵢₙₜ·nᵢₙₜ, wherein nᵢₙₜ is the RB index within the interlace, and cᵢₙₜ is configured by higher layer parameter).

In yet another sub-example, there can be a pre-configured cyclic shift offset between the neighboring RBs (e.g. the cyclic shift includes a term in the form of cᵢₙₜ·nᵢₙₜ, wherein nᵢₙₜ is the RB index within the interlace, and cᵢₙₜ is pre-configured).

In yet another sub-example, the cyclic shift can be determined based on at least an identity from a source ID, a destination ID, or a PSSCH receiver ID.

In yet another sub-example, the cyclic shift can be determined based on the time domain information of the associated PSSCH transmission.

In yet another sub-example, the cyclic shift can be determined based on the frequency domain information of the associated PSSCH transmission.

In one embodiment, a PSFCH transmission can include at least one or multiple interlaces in the frequency domain, wherein each interlace correspond to a set of resource elements (REs) with a uniform interval between two neighboring REs in the frequency domain.

FIG. 9B illustrates an example of a PSFCH transmission occupying one or multiple interlaces in the frequency domain, each interlace corresponding to a set of REs 902 according to embodiments of the present disclosure. The embodiment of the PSFCH transmission occupying one or multiple interlaces in the frequency domain, each interlace corresponding to a set of REs 902 illustrated in FIG. 9B is for illustration only.

In one aspect, the one or multiple interlaces for PSFCH transmission can be determined from a set of interlaces. In one example, the set of interlaces can be associated with the resource pool. In another example, the set of interlaces can be all the interlaces included in the resource pool. In yet another example, the set of interlaces can be further confined within the listen before talk (LBT) bandwidth (e.g., RB-set) where the associated PSSCH is transmitted. In one example, the set of interlaces can be provided to the UE by a pre-configuration. In another example, the set of interlaces can be provided to the UE by a higher layer parameter. In yet another example, the set of interlaces can be provided to the UE by a MAC CE. In one example, the set of interlaces can be provided to the UE by a bitmap, wherein a bit taking value of 1 indicates that the corresponding interlace can be used for PSFCH transmission, and a bit taking value of 0 indicates that the corresponding interlace is not used for PSFCH transmission. In another example, the set of interlaces can be provided to the UE by a starting index and duration of the index (e.g., can be provided separately or jointly using a SLIV).

In another aspect, the index(es) of the one or multiple interlaces can be one or multiple of the following examples.

In one example, it can be the index of the interlace within the resource pool. In another example, it can be the index of the interlace within the BWP. In yet another example, it can be the index of the interlace within the LBT bandwidth (e.g., RB-set) and the resource pool at the same time.

In one further consideration, when a sub-channel corresponds to a RE-based interlace, the index of an interlace can be equivalent to the index of a sub-channel.

In another aspect, the one or multiple interlaces for PSFCH transmission can be determined from the set of interlaces according to one or multiple of the following examples.

In one example, the index(es) of the one or multiple interlaces can be provided to the UE by a pre-configuration. In another example, the index(es) of the one or multiple interlaces can be provided to the UE by a higher layer parameter. In yet another example, the index(es) of the one or multiple interlaces can be provided to the UE by a MAC CE.

In yet another example, the index(es) of the one or multiple interlaces can be provided to the UE by a SCI format (e.g., the SCI which scheduling the PSSCH associated with the PSFCH transmission).

In yet another example, the index(es) of the one or multiple interlaces can be calculated by the UE based on the time domain and/or frequency domain information of the PSSCH associated with the PSFCH transmission.

In yet another aspect, there can be a mapping between a time domain index i and a frequency domain index j to a set of index(es) of interlace(s). For instance, the mapping can be expressed as (i, j) to [(i+j·c₁)·c₂, (i+1+j·c₁)·c₂−1].

In one example, i can be the time domain unit index (e.g., slot index or slot group index) within the number of time domain units (e.g., slots or slot groups) associated with the PSFCH transmission occasion.

In another example, j can be the index of the sub-channel within all sub-channels of the resource pool.

In yet another example, j can be the index of the sub-channel within all sub-channels of the LBT bandwidth (e.g., RB-set) which is the same as the LBT bandwidth of the associated PSSCH transmission.

In yet another example, c₁ can be the number of time domain units (e.g., slots or slot groups) associated with the PSFCH transmission occasion.

In yet another example, c₂=Nᵢₙₜ/Nⱼ·Nᵢ), wherein Nᵢₙₜ is the number of interlaces in the set of interlaces for determining the interlace(s) for PSFCH transmission, Nⱼ is the number of index(es) that j can choose from (e.g. 0≤j≤Nⱼ−1), and Nᵢ is the number of index(es) that i can choose from (e.g. 0≤i≤Nᵢ−1).

In yet another aspect, there can be a mapping between a frequency domain index j to a set of index(es) of interlace(s). For instance, the mapping can be expressed as j to [j·c₂, (j+1) c₂−1].

In one example, j can be the index of the sub-channel within all sub-channels of the resource pool. In another example, j can be the index of the sub-channel within all sub-channels of the LBT bandwidth (e.g., RB-set) which is the same as the LBT bandwidth of the associated PSSCH transmission.

In yet another example, c₂=Nᵢₙₜ/Nⱼ, wherein Nᵢₙₜ is the number of interlaces in the set of interlaces for determining the interlace(s) for PSFCH transmission, Nⱼ is the number of index(es) that j can choose from (e.g. 0≤j≤Nⱼ−1).

In yet another aspect, there can be a one-to-one mapping between a frequency domain index j to an index of interlace. For instance, the index of interlace can be same as the frequency domain index j.

In one example, j can be the index of the sub-channel within all sub-channels of the resource pool. In another example, j can be the index of the sub-channel within all sub-channels of the LBT bandwidth (e.g., RB-set) which is the same as the LBT bandwidth of the associated PSSCH transmission.

In yet another aspect, the transmission of PSFCH is with the same LBT bandwidth (e.g., RB-set) as the transmission of the associated PSSCH. In yet another aspect, the transmission of PSFCH is within the RB-interlace as the transmission of the associated PSSCH.

In yet another aspect, the one or multiple interlaces for PSFCH transmission can be determined based on the time domain and/or frequency domain resources for the associated PSSCH transmission, e.g., based on a mapping described in the example(s) of this disclosure.

In one example, one interlace is selected from the one or multiple interlaces for PSFCH transmission based on the value of i and minimum value of j applicable for the transmission of the associated PSSCH.

In another example, one interlace is selected from the one or multiple interlaces for PSFCH transmission based on the value of i and all values of j applicable for the transmission of the associated PSSCH.

In yet another aspect, a sequence with the length same as the number of REs within the interlace(s) for PSFCH transmission is generated and mapped to the REs.

In one embodiment, a PSFCH transmission can include one or multiple RBs in the frequency domain. In one instance, the one or multiple RBs can be contiguous. In another instance, the one or multiple RBs can be non-contiguous.

FIG. 9C illustrates an example of a PSFCH transmission occupying one or multiple contiguous RBs 903 in the frequency domain according to embodiments of the present disclosure. The embodiment of the PSFCH transmission occupying one or multiple RBs 903 in the frequency domain illustrated in FIG. 9C is for illustration only.

In one aspect, the one or multiple RBs for PSFCH transmission can be determined from a set of RBs. In one example, the set of RBs can be associated with the resource pool. In another example, the set of RBs can be all the RBs included in the resource pool. In yet another example, the set of RBs can be further confined within the listen before talk (LBT) bandwidth (e.g. RB-set) where the associated PSSCH is transmitted. In one example, the set of RBs can be provided to the UE by a pre-configuration. In another example, the set of RBs can be provided to the UE by a higher layer parameter. In yet another example, the set of RBs can be provided to the UE by a MAC CE. In one example, the set of RBs can be provided to the UE by a bitmap, wherein a bit taking value of 1 indicates that the corresponding RB can be used for PSFCH transmission, and a bit taking value of 0 indicates that the corresponding RB is not used for PSFCH transmission. In another example, the set of RBs can be provided to the UE by a starting index and duration of the index (e.g., can be provided separately or jointly using a SLIV).

In another aspect, the one or multiple RBs for PSFCH transmission can be determined from the set of RBs according to one or multiple of the following examples:

In one example, the index(es) of the one or multiple RBs can be provided to the UE by a pre-configuration. In another example, the index(es) of the one or multiple RBs can be provided to the UE by a higher layer parameter. In yet another example, the index(es) of the one or multiple RBs can be provided to the UE by a MAC CE.

In yet another example, the index(es) of the one or multiple RBs can be provided to the UE by a SCI format (e.g., the SCI which scheduling the PSSCH associated with the PSFCH transmission).

In yet another example, the index(es) of the one or multiple RBs can be calculated by the UE based on the time domain and/or frequency domain information of the PSSCH associated with the PSFCH transmission.

In one example, the number of RBs can be provided to the UE by a pre-configuration. In another example, the number of RBs can be provided to the UE by a higher layer parameter. In yet another example, the number of RBs can be provided to the UE by a MAC CE. In yet another example, the number of RBs can be provided to the UE by a SCI format (e.g., the SCI which scheduling the PSSCH associated with the PSFCH transmission).

In yet another aspect, there can be a mapping between a time domain index i and a frequency domain index j to a set of index(es) of interlace(s). For instance, the mapping can be expressed as (i, j) to [(i+j·c₁)·c₂, (i+1+j·c₁)·c₂−1].

In one example, i can be the time domain unit index (e.g., slot index or slot group index) within the number of time domain units (e.g., slots or slot groups) associated with the PSFCH transmission occasion.

In another example, j can be the index of the sub-channel within all sub-channels of the resource pool.

In yet another example, j can be the index of the sub-channel within all sub-channels of the LBT bandwidth (e.g., RB-set) which is the same as the LBT bandwidth of the associated PSSCH transmission.

In yet another example, c₁ can be the number of time domain units (e.g., slots or slot groups) associated with the PSFCH transmission occasion.

In yet another example, c₂=Nᵢₙₜ/(Nⱼ·Nᵢ), wherein Nᵢₙₜ is the number of RBs in the set of RBs for determining the RB(s) for PSFCH transmission, Nⱼ is the number of index(es) that j can choose from (e.g. 0≤j≤Nⱼ−1), and Nᵢ is the number of index(es) that i can choose from (e.g. 0≤i≤Nᵢ−1).

In yet another aspect, there can be a mapping between a frequency domain index j to a set of RB(s). For instance, the mapping can be expressed as j to [j·c₂, (j+1)·c₂−1].

In one example, j can be the index of the sub-channel within all sub-channels of the resource pool. In another example, j can be the index of the sub-channel within all sub-channels of the LBT bandwidth (e.g., RB-set) which is the same as the LBT bandwidth of the associated PSSCH transmission.

In yet another example, c₂=Nᵢₙₜ/Nⱼ, wherein Nᵢₙₜ is the number of RBs in the set of RBs for determining the RB(s) for PSFCH transmission, Nⱼ is the number of index(es) that j can choose from (e.g. 0≤j≤Nⱼ−1).

In yet another aspect, the transmission of PSFCH is with the same LBT bandwidth (e.g., RB-set) as the transmission of the associated PSSCH.

In yet another aspect, the one or multiple RBs for PSFCH transmission can be determined based on the time domain and/or frequency domain resources for the associated PSSCH transmission, e.g., based on a mapping described in the example(s) of this disclosure.

In one example, the one or multiple RBs for PSFCH transmission can be selected based on the value of i and minimum value of j applicable for the transmission of the associated PSSCH.

In another example, the one or multiple RBs for PSFCH transmission can be selected based on the value of i and all values of j applicable for the transmission of the associated PSSCH.

In yet another aspect, the sequence mapped to the RB(s) for PSFCH transmission can be determined from one or multiple of the following examples:

In one example, a sequence with the length that is same as the number of REs within all the RB(s) for PSFCH transmission is generated and mapped to the REs.

In another example, a sequence with the length that is same as the number of REs within one RB is generated, and the sequence is applied with a cyclic shift and mapped to each RB within all the RB(s) for PSFCH transmission, wherein the cyclic shift depends on the RB index within all the RB(s) for PSFCH transmission.

In one sub-example, there can be a fixed cyclic shift offset between the neighboring RBs (e.g. the cyclic shift includes a term in the form of cᵢₙₜ·nᵢₙₜ, wherein nᵢₙₜ is the RB index within all the RB(s) for PSFCH, and cᵢₙₜ is a fixed value. For instance, cᵢₙₜ=5. In another instance, cᵢₙₜ=2. In yet another instance, cᵢₙₜ=3).

In another sub-example, there can be a configured cyclic shift offset between the neighboring RBs (e.g. the cyclic shift includes a term in the form of cᵢₙₜ·nᵢₙₜ, wherein nᵢₙₜ is the RB index within all the RB(s) for PSFCH, and cᵢₙₜ is configured by higher layer parameter).

In yet another sub-example, there can be a pre-configured cyclic shift offset between the neighboring RBs (e.g. the cyclic shift includes a term in the form of cᵢₙₜ·nᵢₙₜ, wherein nᵢₙₜ is the RB index within all the RB(s) for PSFCH, and cᵢₙₜ is pre-configured).

In yet another sub-example, the cyclic shift can be determined based on at least an identity from a source ID, a destination ID, or a PSSCH receiver ID.

In yet another sub-example, the cyclic shift can be determined based on the time domain or frequency domain information of the associated PSSCH transmission.

In one embodiment, a PSFCH transmission can occupy all the RBs in the frequency domain, wherein all the RBs are within a RB-set and/or a SL BWP and/or a resource pool.

FIG. 9D illustrates an example of a PSFCH transmission occupying all RBs 904 in the frequency domain according to embodiments of the present disclosure. The embodiment of the PSFCH transmission occupying all RBs 904 in the frequency domain illustrated in FIG. 9D is for illustration only.

In one aspect, all the RBs for PSFCH transmission can be determined using at least one of the following examples.

In one example, all the RBs for PSFCH can be all the RBs included in the resource pool. In another example, all the RBs for PSFCH can be further confined within a LBT bandwidth (e.g., RB-set). In one sub-example, the RB-set can be the one where the associated PSSCH is transmitted. In another sub-example, when the associated PSSCH transmission spans multiple RB-sets, the RB-set can be determined as the one with the lowest index, or highest index, or with an index provided by a (pre-)configuration, or with an index provided by a sidelink control information (SCI) format. In yet another sub-example, when the associated PSSCH transmission spans multiple RB-sets, the RB-set can be determined as everyone in the multiple RB-sets, e.g., PSFCH is transmitted in every RB-set within the multiple RB-sets. In yet another sub-example, when the associated PSSCH transmission spans multiple RB-sets, the RB-set can be determined as one or multiple from the multiple RB-sets, wherein the one or multiple RB-set can be provided by a (pre-)configuration, or by a SCI format.

In yet another example, all the RBs for PSFCH can be provided to the UE by a pre-configuration. In yet another example, all the RBs for PSFCH can be provided to the UE by a higher layer parameter. In yet another example, all the RBs for PSFCH can be provided to the UE by a MAC CE.

In one example, all the RBs for PSFCH can be provided to the UE by a bitmap, wherein a bit taking value of 1 indicates that the corresponding RB can be used for PSFCH transmission, and a bit taking value of 0 indicates that the corresponding RB is not used for PSFCH transmission.

In another example, all the RBs for PSFCH can be provided to the UE by a starting index and duration of the index (e.g., can be provided separately or jointly using a SLIV).

In yet another aspect, the sequence for PSFCH transmission, which is mapped to the RB(s), can be determined from one or multiple of the following examples:

In one example, a sequence with the length that is same as the number of REs within all the RB(s) for PSFCH transmission is generated and mapped to the REs.

In another example, a sequence with the length same as the number of REs within one RB is generated, and the sequence is applied with a cyclic shift and mapped to each RB within all the RB(s) for PSFCH transmission, wherein the cyclic shift depends on the RB index within all the RB(s) for PSFCH transmission.

In one sub-example, there can be a fixed cyclic shift offset between the neighboring RBs (e.g. the cyclic shift includes a term in the form of cᵢₙₜ·nᵢₙₜ, wherein nᵢₙₜ is the RB index within all the RB(s) for PSFCH, and cᵢₙₜ is a fixed value. For instance, cᵢₙₜ=5. In another instance, cᵢₙₜ=2. In yet another instance, cᵢₙₜ=3).

In another sub-example, there can be a configured cyclic shift offset between the neighboring RBs (e.g. the cyclic shift includes a term in the form of cᵢₙₜ·nᵢₙₜ, wherein nᵢₙₜ is the RB index within all the RB(s) for PSFCH, and cᵢₙₜ is configured by higher layer parameter).

In yet another sub-example, there can be a pre-configured cyclic shift offset between the neighboring RBs (e.g. the cyclic shift includes a term in the form of cᵢₙₜ·nᵢₙₜ, wherein nᵢₙₜ is the RB index within all the RB(s) for PSFCH, and cᵢₙₜ is pre-configured).

In yet another sub-example, the cyclic shift can be determined based on at least an identity from a source ID, a destination ID, or a PSSCH receiver ID.

In yet another sub-example, the cyclic shift can be determined based on the time domain information of the associated PSSCH transmission.

In yet another sub-example, the cyclic shift can be determined based on the frequency domain information of the associated PSSCH transmission.

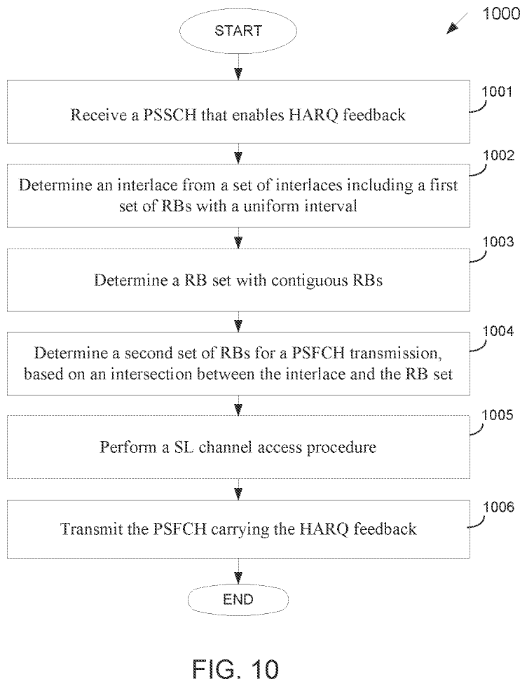

FIG. 10 illustrates a flowchart of a method 1000 for a UE procedure for a PSFCH transmission occupying one or multiple interlaces in the frequency domain, each interlace corresponding to a set of resource blocks (RBs) according to embodiments of the present disclosure. The embodiment of the method 1000 illustrated in FIG. 10 is for illustration only. The method 1000 can be performed by a UE (e.g., 111-116 as illustrated in FIG. 1). One or more of the components illustrated in FIG. 10 can be implemented in specialized circuitry configured to perform the noted functions or one or more of the components can be implemented by one or more processors (e.g., processor 340) executing instructions to perform the noted functions.

As illustrated in FIG. 10, a UE first receives a PSSCH (block 1001). The received PSSCH enables a HARQ feedback. The UE determines an interlace from a set of interlaces according to the examples in this disclosure (block 1002). In some embodiments, each interlace in the set of interlaces includes a first set of RBs with a uniform interval. UE further determines an RB set, wherein the RB set includes contiguous RBs (block 1003). UE further determines a second set of RBs for PSFCH transmission according to the examples in this disclosure (block 1004). In one embodiment, the second set of RB are determined based on an intersection between the interlace and the RB set. UE further performs a SL channel access procedure (block 1005) and after successfully performing the SL channel access procedure, the UE transmits the PSFCH carrying the HARQ feedback in the second set of RBs (block 1006).

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

The descriptions above are only the preferable embodiment of the disclosure, which are not used to restrict the disclosure. For those skilled in the art, the disclosure may have various changes and variations. Any amendments, equivalent substitutions, improvements, etc. within the principle of the disclosure are all included in the scope of the protection of the disclosure. Further, when a particular feature, structure, or characteristic is described in connection with an embodiment, it is submitted that it is within the knowledge of one skilled in the art to implement such feature, structure, or characteristic in connection with other embodiments, whether or not explicitly described. The scope of patented subject matter is defined by the claims.

What is claimed is:

1. A user equipment (UE) in a wireless communication system operating with a shared spectrum channel access, the UE comprising:
a transceiver configured to receive a physical sidelink shared channel (PSSCH), wherein the PSSCH enables a hybrid automatic repeat request (HARQ) feedback; and
a processor operably coupled to the transceiver, the processor configured to:
determine an interlace from a set of interlaces, wherein each interlace in the set of interlaces includes a first set of resource blocks (RBs) with a uniform interval;
determine a RB set, wherein the RB set includes contiguous RBs;
determine, based on an intersection between the interlace and the RB set, a second set of RBs for a physical sidelink feedback channel (PSFCH) transmission; and
perform a sidelink (SL) channel access procedure,
wherein the transceiver is further configured to transmit, after successfully performing the SL channel access procedure, the PSFCH carrying the HARQ feedback in the second set of RBs.

2. The UE of claim 1, wherein:
the set of interlaces are indicated by higher layer parameter using a bitmap, and
each bit in the bitmap corresponds to an interlace in a SL resource pool.

3. The UE of claim 2, wherein:
a bit in the bitmap with a value of 1 indicates that a corresponding interlace is included in the set of interlaces, and
a bit in the bitmap with a value of 0 indicates that a corresponding interlace is not included in the set of interlaces.

4. The UE of claim 1, wherein the processor is further configured to determine, based on a first index of a slot where the PSSCH is received and a second index of a sub-channel, an index of the interlace.

5. The UE of claim 4, wherein the second index of the sub-channel is a minimum value among indexes of sub-channels where the PSSCH is received.

6. The UE of claim 1, wherein the processor is further configured to determine the RB set as a RB set with a lowest index among all RB sets where the PSSCH is received.

7. The UE of claim 1, wherein the processor is further configured to, for each RB in the second set of RBs for the PSFCH transmission:
generate a sequence, wherein a length of the sequence equals to a number of resource elements (REs) in the RB;
determine a cyclic shift mᵢₙₜ;
apply the cyclic shift mᵢₙₜ to the sequence; and
map the applied sequence to the RB.

8. The UE of claim 7, wherein the cyclic shift mᵢₙₜ is based on a third index flint of the RB within the second set of RBs for the PSFCH transmission, where mᵢₙₜ=5·nᵢₙₜ.

9. The UE of claim 1, wherein a number of RBs in the second set of RBs for the PSFCH transmission is at least 10.

10. The UE of claim 1, wherein a sub-carrier spacing (SCS) of RBs in the second set of RBs for the PSFCH transmission is 15 kilohertz (kHz) or 30 kHz.

11. A method of user equipment (UE) in a wireless communication system operating with a shared spectrum channel access, the method comprising:
receiving a physical sidelink shared channel (PSSCH), wherein the PSSCH enables a hybrid automatic repeat request (HARQ) feedback;
determining an interlace from a set of interlaces, wherein each interlace in the set of interlaces includes a first set of resource blocks (RBs) with a uniform interval;
determining a RB set, wherein the RB set includes contiguous RBs;
determining, based on an intersection between the interlace and the RB set, a second set of RBs for a physical sidelink feedback channel (PSFCH) transmission;
performing a sidelink (SL) channel access procedure; and
transmitting, after successfully performing the SL channel access procedure, the PSFCH carrying the HARQ feedback in the second set of RBs.

12. The method of claim 11, wherein:
the set of interlaces are indicated by higher layer parameter using a bitmap, and
each bit in the bitmap corresponds to an interlace in a SL resource pool.

13. The method of claim 12, wherein:
a bit in the bitmap with a value of 1 indicates that a corresponding interlace is included in the set of interlaces, and
a bit in the bitmap with a value of 0 indicates that a corresponding interlace is not included in the set of interlaces.

14. The method of claim 11, further comprising determining, based on a first index of a slot where the PSSCH is received and a second index of a sub-channel, an index of the interlace.

15. The method of claim 14, wherein the second index of the sub-channel is a minimum value among indexes of sub-channels where the PSSCH is received.

16. The method of claim 11, wherein determining the RB set further comprises determining the RB set as a RB set with a lowest index among all RB sets where the PSSCH is received.

17. The method of claim 11 further comprising, for each RB in the second set of RBs for the PSFCH transmission:
generating a sequence, wherein a length of the sequence equals to a number of resource elements (REs) in the RB;
determining a cyclic shift mᵢₙₜ;
applying the cyclic shift mᵢₙₜ to the sequence; and
mapping the applied sequence to the RB.

18. The method of claim 17, wherein the cyclic shift mᵢₙₜ is based on a third index Hint of the RB within the second set of RBs for the PSFCH transmission, where mᵢₙₜ=5·nᵢₙₜ.

19. The method of claim 11, wherein a number of RBs in the second set of RBs for the PSFCH transmission is at least 10.

20. The method of claim 11, wherein a sub-carrier spacing (SCS) of RBs in the second set of RBs for the PSFCH transmission is 15 kilohertz (kHz) or 30 kHz.
